(19) United States
(12) Patent Application Publication
(10) Pub. No.: US 2021/0308590 A1
(43) Pub. Date: Oct. 7, 2021

(54) GAMIFIED SIGNAL TRANSMITTING SYSTEM FOR INCENTIVIZED ENGAGEMENT

(71) Applicant: Phillip J. Ross, Saltsburg, PA (US)

(72) Inventor: Phillip J. Ross, Saltsburg, PA (US)

(21) Appl. No.: 17/221,575

(22) Filed: Apr. 2, 2021

Related U.S. Application Data
(60) Provisional application No. 63/003,928, filed on Apr. 2, 2020.

(51) Int. Cl. A63F 13/803; A63F 13/79

(52) U.S. Cl. CPC A63F 13/803; A63F 13/79

(57) ABSTRACT

A method of playing a game, including registering a plurality of players to play the game, wherein the plurality of players are registered as digital vehicles, creating user profiles based on registration information of the plurality of players, presenting a race link to the plurality of players, notifying the plurality of players of a beginning of the race, unveiling a track to the plurality of players on which to receive the digital vehicles, and accelerating the digital vehicles around the track based on player input of assigned values into assigned value spaces of the track.

### CROSS REFERENCE TO

This application claims priority under 35 U.S.C. § 119(e) and all relevant statutes from the benefit of U.S. Provisional Patent Application No. 63/003,928 filed Apr. 1, 2020 which is hereby incorporated by reference for all purposes as if fully set forth herein.

### TECHNICAL FIELD

Example embodiments disclosed herein relate generally to an electronic gaming system such as a gamified engagement ecosystem configured to generate revenue, track behavior, and perform various analyses to achieve desired results.

### BRIEF DESCRIPTION OF THE DRAWINGS

Additional objects and features of the invention will be more readily apparent from the following detailed description and appended claims when taken in conjunction with the drawings. Although several example embodiments are illustrated and described, like reference numerals identify like parts in each of the figures, in which:

FIG. 1A illustrates a sample distance line in accordance with embodiments described herein;

FIG. 1B illustrates variations of the signal line in accordance with FIG. 1A;

FIG. 2 illustrates a QTrack block in accordance with embodiments described herein;

FIG. 3A illustrates a container in accordance with embodiments described herein;

FIG. 3B illustrates a number of blocks in a QTrack in accordance with FIG. 3A;

FIG. 4 illustrates one version of a QTrack atmosphere in accordance with embodiments described herein;

FIG. 5 illustrates a cube version of a QTrack race in accordance with embodiments described herein;

FIG. 6 illustrates a virtual reality representation of a digital environment in accordance with embodiments described herein;

FIGS. 7, 8, 9, and 10 illustrate examples of value racing in accordance with embodiments described herein; and

FIG. 11 illustrates a method of determining a winner of value racing in accordance with FIGS. 7, 8, 9, and 10.

### DETAILED DESCRIPTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various example embodiments described herein are not necessarily mutually exclusive, as some example embodiments can be combined with one or more other example embodiments to form new example embodiments. Descriptors such as “first,” “second,” “third,” etc., are not meant to limit the order of elements discussed, are used to distinguish one element from the next, and are generally interchangeable. Values such as maximum or minimum may be predetermined and set to different values based on the application.

To help characterize concepts described herein, some useful terms may be used. Any definitions provided are not limited to the meaning described but are provided by way of example to assist the reader to understand features described herein.

A signal may be a gesture, action, or sound that is used to convey information or instructions, typically by pre-arrangement between two or more parties. A signal may also be termed a data stream, data content, data flow, or the like.

To transit or a transmission may refer to passing from one place or person to another place or person. A transmission may also include an action or process of transmitting something, or the state of being transmitted.

Competitors may include members such as an end-user, racer, user, student, athlete, and other terms described herein.

An Assigned Value may be a specified palette, character, file, or value designated to fit a specific space along a Vector (A,B), other suitable vector or track, as well as fuel for which a signal may move.

Assigned Value Space may refer to space along a Vector (A,B) for which an Assigned Value may be inputted. The Assigned Value Space may mark a distance for which a signal must travel along the vector (A, B) to be transmitted.

Input Value may refer to any value that has been inputted to an Assigned Value Space whether it be the Assigned Value or Unassigned Value occupying a space.

An Input Mechanism or Apparatus may be characterized as a mechanism or apparatus used for manual input of a value into an Assigned Value Space.

A Puzzle may be one or a series of Assigned Value Spaces represented by a two dimensional or three-dimensional palette or box in which single or multiple possible values fit.

Input Value Speed may refer to an interval timing between Input Values using an Input Mechanism or Apparatus with respect to accuracy.

A Virtual Bot (vBot) may be an electronic or digital vehicle that represents a piece or portion of a signal. The piece or portion may be equal to the number of vBots or competitors participating in a transmission of information across a digital environment or Vector (A,B) in the form of a race.

Point “A” may refer to a Starting Line, pivot, or current position of an object (vBot) along Vector (A,B). Point “B” may refer to a Finish Line, end point, midway point, or destination of an object (vBot) moving along Vector (A,B).

A QTrack may be characterized as a physical hardware driven, electronic, digital, virtual, or augmented reality race track. The Qtrack may be configured along the Vector (A,B). On the Qtrack, a vBot is able to accelerate through, within, or on top of that which is dependent on the correctly sequenced manual Input Value Speed of the Assigned Value in relation to the available Assigned Value Spaces. The QTrack may also be reused for various units of measurement, level changes, and other meaningful metrics that to be visually represented to an end-user under diverse circumstances and non-race related activity.

A Screen/View may be present on a mobile device, virtual reality (VR) hardware or software system, a computer system, augmented reality (AR) hardware of software, holographic hardware or software, television, or audio representation of a QTrack. A user is able to interact with the screen/view for the purposes of competing in a competition such as a contest.

Community Based Participatory Research (CBPR) may refer to research in which a community is cooperatively participating and empowered in doing so.

QSCORA stands for Quantum Supply Chain of Reason and Action.

The system or platform described herein may be referred to as system, platform, gamified ecosystem, or gamified engagement ecosystem.

An Automated Missed Assigned Input Value Repository with Correction Feature may be used in which competitors use various methods to input values with a goal of inputting sequenced assigned values with an opportunity to make a mistake by incorrectly entering a value. When a mistake in a sequence is made by one or more users, the gamified ecosystem provides an ability to inform the one or more users of the mistake. A mistake may be a single mistake or multiple. Information about the mistake may be delayed or made in real-time. When in real time the user is notified right after the mistake is made, such as after a keystroke has been pushed and executed, and a user may fix a mistake after the notification. Delayed notification may be after a user has entered a designated string of characters. The user may be allowed to fix a mistake after the string has been entered. When a user is allowed to fix a mistake, an erroneous character or characters is removed from a string and replaced by a newly typed character or characters. Alternatively the erroneous character(s) is left in place but ignored when the user types a replacement character. These functions remove the ability of a user or competitor to use the delete button as they are typing or traveling in a line on the Screen/View which over time may be inconvenient. Thus corrections may be made without using the delete button. Characters in this example may be replaced by human actions when a Qtrack is a human activity to be monitored or directed.

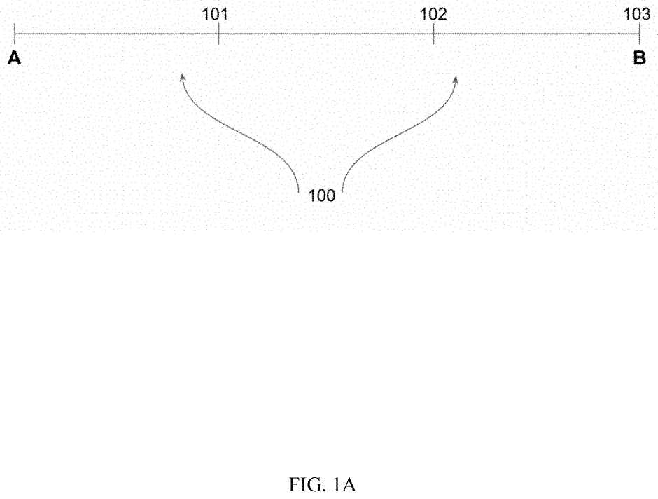

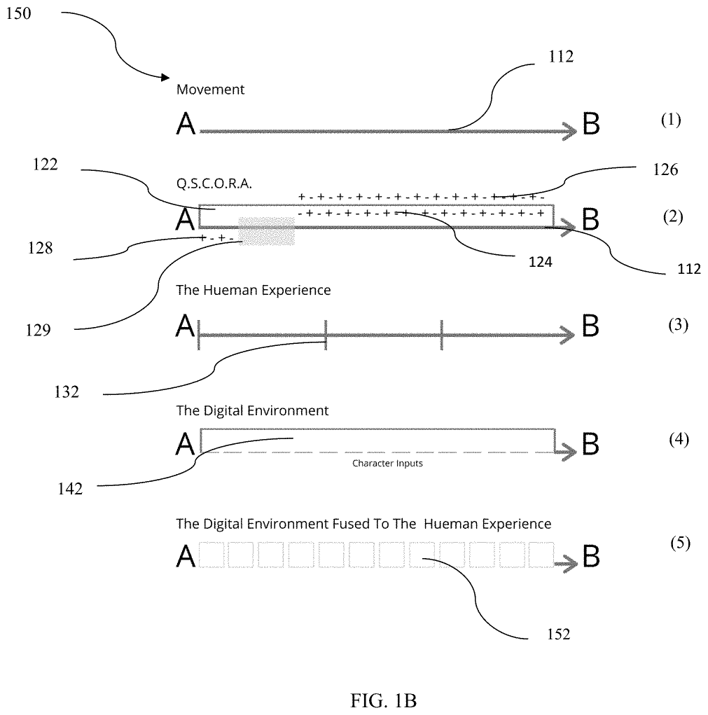

FIG. 1A illustrates a sample distance line 100 in accordance with embodiments described herein. The distance line 100 may be extended between a Point “A” and a Point “B,” known as vector (A,B). The distance line 100 may be divisible into an almost infinite number of segments by splitting the distance line 100 in half any number of times. For example, the distance line 100 may be broken into four segments denoted by markers 101, 102, and 103. This number may be increased by a greater number until the number of markers reaches infinity, or to what is mathematically possible based on the length of the distance line 100 and the size of the segments.

In a digital, computer, mobile, or virtual environment a distance between A and B within the context of the transmission of a signal between two locations abides by similar rules. While the distance appears fixed between A and B, if the distance line 100 is broken into multiple segments by multiple markers, each marker may be a new distance for a signal to traverse. Also a distance between A and B may go off into different directions to elongate the distance traveled. Thus a signal transmitting from one point to the next may be broken down into one or more, or possibly a much larger number of spaces or segments.

Embodiments described herein use the distance line 100 between two points such as A and B in a digital environment and gamify a luminal space between the two points by dividing and compartmentalizing that distance into segments. A luminal space may be described as a distance between two digital markers in a data stream or signal.

Embodiments described herein may be used in a competitive arena such as a sports-based medium nestled within a quantum digital environment of a signal or data stream being transmitted from one point to another.

FIG. 1B illustrates aspects 150 of the signal line 100 in accordance with FIG. 1A. Section (1) illustrates movement from A to B along a race line 112. In section (2) along the race line 112, a QTrack 122 may be established.

Embodiments include a signal, data stream, or other race being able to move across the QTrack 122. The vector (A, B) that defines the QTrack 122 may be a URL but can take on other forms or activities as described herein. One example of an activity includes community-based participator research.

Segment (2) may reflect QSCORA, quantum supply chain of reason and action. Because the race line 112 A to B allows transmission of signal on small scale, a breaking up of an actual signal into bits, called Bit Racing™, the signal becomes information, and is formatted to be raced. A manual race may be performed by a signal from A to B. Because the race line 112 can be broken into small pieces, it may be deemed quantum, including small particles, as illustrated in segment (5). Because the race line 112 may be broken into pieces, movement such as velocity of the smaller pieces can be measured.

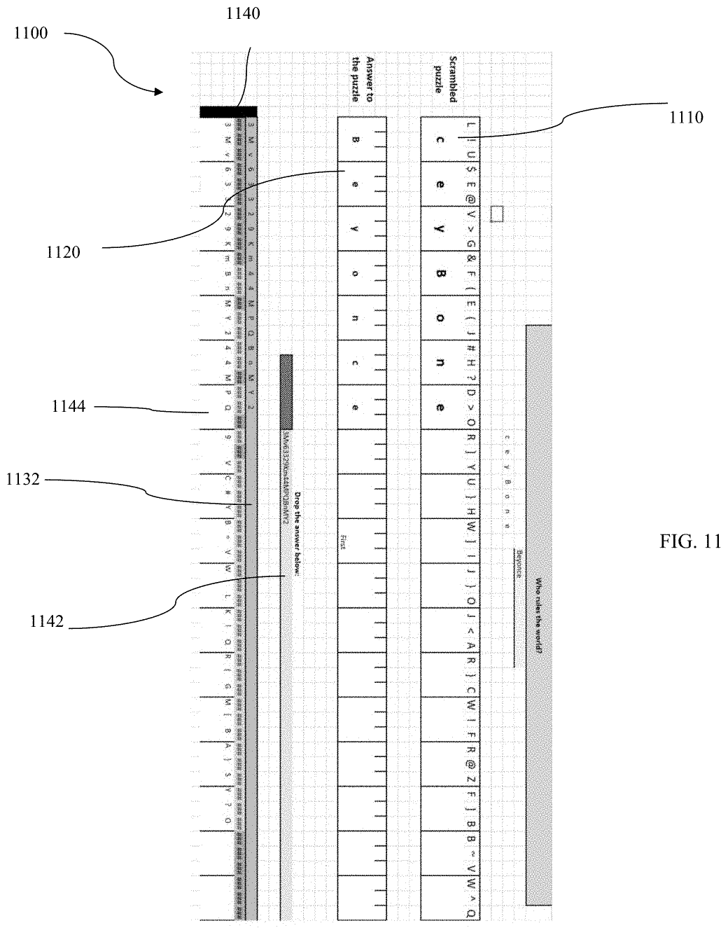

Within the QTrack 122 are a number of symbols 124, here illustrated as pluses and minuses, but embodiments are not limited thereto. The plusses and minuses are placeholders for any type of characters or movement through a QTrack. The symbols 124 represent the correct answer of stored data that has to be entered by a competitor to win a race. The symbols 126 above the QTrack 122 represent symbols or characters that a competitor has actually entered or is entering during a competition. Once the user has entered their characters 126, a comparison is performed to determine whether the symbols 126 match the symbols 124 (illustrated in FIG. 11). In a given race, there may be multiple symbol sets 126 inputted by various users to determine a winner, or to determine compliance with a prescribe regime or activity. Once symbols 126 are entered by a user, the gamified engagement ecosystem generates a receipt 128 of characters configured to identify characteristics of the entered symbols 126. Receipt 128 components may include speed of character entry, time of entry, length of entry, and actual entry.

The inputted symbols 126 may be used to determine a velocity of characters, text, or bits moving between A and B, with the receipt data 128 registering the characteristics entered. The receipt data 128 can be evaluated or audited with regard to vBots. Within segment (2) there is a vBot 129 illustrated.

The vBot 129 may be described as a virtual representation of the progress being made by a competitor in a race. The vBot 129 may be a vehicle or take on many forms. The vBot 129 may be visible on screen, or hidden within a program, though data is still being recorded.

Section (3) represents the hueman experience, a physical environment of a human user. This represents that a QTrack 122 may not merely be a race on a computer, from one URL to another, but a QTrack 122 may me a way of tracking progress of a person to complete one or more of any number of tasks in their personal or professional life. Tasks could include job seeking, personal health, prescribed health, and so on.

In such a case, the gamified ecosystem allows a person's steps or stages to be tracked until a goal is reached. Using VR or AR glasses, a user may track their movements along a QTrack. Take physical therapy, for example. A user wearing VR or AR glasses may be prompted to move a body part in a particular way. The glasses will be programmed to track the movement or send recognition of the movements to the system described herein. When the user performs the body movement as directed or for a certain number of times, the user's vBot will move one or more spaces along the QTrack. Fulfilling the prescribed movements will fill out characters on the QTrack and move the vBot along.

In another example, the gamified ecosystem may allow a user to learn a musical instrument. When a user is prompted to play certain chords or beats on the instrument, the vBot is moved along the QTrack. The system may be used for shopping, for education, or other tasks. A user may be directed to shop online and perform various tasks, which move the vBot when successfully completed. A student may be directed to take various classes and perform to a certain standard.

Section (4) is another representation of the digital environment illustrating character inputs 142 from A to B. Section. Section (5) illustrates that moving from A to B, the distance may be broken up into blocks 152. In the fifth segment a movement, action, course of study, etc. may be broken up into pieces so that it is not one fluid motion. The person is able to interact with the individual pieces.

As described herein, in a digital environment actionable identified pieces of information such as data, bits or bytes are able to be transmitted between two points in a signal or data stream. Embodiments described herein may atomize a data stream (break it into a number of pieces) and convert each piece of the data stream into a bit-sized unit known as a vBot. A plurality of vBots may represent a quantity of individuals, racers, competitors, users, etc. The competitors may then race these vBots across a length of the distance line 100 (illustrated in FIG. 1A) in which the signal or data stream is represented.

The vBot races performed by the competitors may be done using various methods.

Competitors may use manual activities that they perform such as users typing on a keyboard to achieve a string of characters. Competitors may sing/rap a song or a portion of a song as input. Users may draw a picture or a portion of a picture. Using mobile devices, users may ride a bike or use exercise equipment. Sports with sensor-based measuring may be used, such as boxing, basketball, wrestling, Olympic sports, dancing, physical therapy movements, and yoga, for example. Students may complete homework exercises quickly and correctly in a type of competition, or to achieve a grade. Online testing may be used in a race format.

Within each gamified transmission a predetermined number of vBots must reach the destination of Point “B” before the signal is able to be converted from a manual human input-based speed to the automatic computer or technology processor speeds of kilobytes to petabytes per second. This conversion is based on an algorithm that dynamically expands and contracts based on the number of competitors/vBots within a transmission marking the end of the Race. Before the programmed transmission of the signal, a program embedded within the competition system is able to assign a place finishing order or matrix for which of the vBots are the fastest. This is one of many ways to identify winning from the losing competitors.

Winners of a race are assigned a designated form of value associated with the subject matter of the competitive sporting environment, arena, or venue that takes place. Participating competitor inputs are tracked to allow for peripheral values to be assigned an engagement level. This tracked peripheral value allots each racer a score that can be used to inform user classes within the platform. The tracked peripheral value may be made available to the competitors, sponsors, advertisers, analyzers, funders, investors, spectators, venues, developers, digital signaling technologies, machine learning, mobile applications, web applications, and algorithms of a race.

Embodiments described herein include methods of game play. Embodiments include an online and/or offline sports contest that combines puzzles, logic, typing accuracy, and typing speed (both mental and physical/musculoskeletal demanding) to challenge one or a small to large group of competitors to observe, interpret, solve and submit solutions in a whole, in parts, or in sections (input values) into or onto a digital or virtual race track. The virtual race track may include Assigned Value Spaces (segments) into which a puzzle is embedded and utilized as a venue and digital environment. In this virtual race track a digital, electronic, or virtual bot (vBot) representing a single competitor or a group of competitors acting as one vBot are able to compete with each other or against a computer system or algorithm by accelerating their respective vBot(s) through or on top of the digital, virtual, or augmented reality track (QTrack).

The acceleration of each vBot is dependent on sequential manual inputs of properly Assigned Values that correspond to the Assigned Value Spaces provided along the Vector (A,B) 100 (illustrated in FIG. 1) representing the digital environment hosting the embedded puzzle(s) within the QTrack.

Competitors may compete directly with one another head-to-head or through group or crowd options. Competitors may accelerate their respective vBot across the QTrack in a virtual or digital racing event using mobile devices, computer systems, or other apparatuses including but not limited to hardware to software, hardware to hardware, software to software, and software to hardware technologies. Such technologies may that accurately record and facilitate digitized input values from the physical world or corresponding digital environment into a vBot may can travel within an electronic, or virtual medium.

Input Value Speeds of competitors may be manually engaged using various skills and physical/musculoskeletal abilities. The Input Value Speeds may be measured and generate a receipt for the completion of an interaction or measured form of engagement. The cumulative distance traveled by each competitor through the lens and perspective of a vBot through or on top of the designated QTrack(s) may be recorded and audited and used for matching competitors in real-time with similarly skilled athletes and vBot racers. This matching may be based on one component of or several measurable variables when combined amounts to a fair and competitive skill set.

Each vBot may be assigned a completion receipt to confirm the number of Assigned Value Spaces traversed by a competitor before a designated number “x” vBots have arrived at the final destination Point “B” of Vector (A,B). The completion receipt may allow for either a signal to be transmitted or the observable end of a contest. This is a way to measure incremental stages of a contest from Point “A” to Point “B”. This may represent the Finish Line for a Q Track Race across Digital Space and Time as well as a staging area for the next leg of a larger competition.

Competitors who cross the digital threshold from Point “A” of a QTrack to Point “B” the fastest will win a designated value or prize that may be transferred to a digital or physical account such as a wallet, profile, station, point of sale, 3rd party, or account of the competitor's choosing. This value transfer may be in the form of a monetary note, non-monetary note, asset, alternative financial instrument, crypto, gift, or prize of any kind.

Embodiments including a digital platform described herein may be broken into several subcategories that allow for it to intersect with several markets including but not limited to sports, entertainment, e-sports, research, e-commerce, marketing, advertising, finance, real estate, politics, health & wellness, fund-raising, photography, digital illustration, multimedia, sponsorship, education-based programming, computer processing, digital mining, online games, video games, virtual and augmented reality, supply-chain and logistics, energy, and others.

Embodiments include competition access and marketing. Embodiments include an unlimited number of QTrack competitions that may be designed for various niche communities, demographic profiles or end-users to compete with one another individually or in small or large groups. Engagement may be based on direct engagement promotion and marketing tactics including but not limited to physical locations, campaigns, events, within Internet of Things “IoT”, forums, channels, VoIP platforms, hack-a-thons, social media, direct media, and television. Engagements may also be provided through indirect and online engagements using on-boarding tools as a differentiator of profiles to aggregate various types of competitions for a series of niche and diverse communities or profiles with a unique or special need.

Competitors may select contest(s) or competition(s) to compete one at a time or several at the same time. One or more contests may be set for a specific time. When a contest is set, the QTrack will be revealed to all competitors at the same time through varying streams of media to signal the “Start Time” of the competition. Competitors are informed when a competition is over in real-time or later after a race.

In one example, a future competitor/end-user may hear about a contest through any online or offline medium including but not limited to social media, television, websites, text messages, electronic mail, zip files, or project management software in which one or more individuals or groups are able to communicate. Communication may include online flyers, advertisements, and promotions including but not limited to online magazines as well as through physical literature such as newspapers, magazines, word of mouth, NIC, link sharing systems and platforms, etc.

In the example, an end-user could then be led to an online or offline location to register and become a member or enter a future competition by providing information that may or may not be identified. The information may be used to create a profile for which their digital presence can be quantified for the purposes of either one specific competition, future competitions of similar likeness or scopes, or different competitions with dis-similar variances.

The end-user after registration may then be asked to select the competition for which they want to compete if they have not already been prompted or added to a competition through automated methods for a set specific time in a real world, virtual, or digital environment-based time zone. The end-user may then be presented with a link to or through an application. Alternatively login access may be presented with the opportunity to become present at Point “A” of a QTrack which is seen as the “Starting Line” or point of reference in which the beginning or a specific leg of the race will begin.

Near the designated time of the contest the competitor will tune, login, or link into a channel, platform, VoIP Link (similar to Zoom, Skype), application and see a blank screen with or without instructions with a notification or countdown to the time of the start of the contest. When the countdown is completely executed this will prompt the unveiling of the QTrack along with any additional clues, directions, or tips that need to be interpreted by the end-users/competitors desiring to accelerate their vBot. Acceleration of the vBot may be accomplished using the speed of one's intellect and speed of their ability to input the properly Assigned Values into the Assigned Value Spaces of the QTrack faster than their competitors.

The gamified engagement ecosystem allows the competitor/end-user to then use his/her Input Value Mechanism or Apparatus to the best of their ability to advance or accelerate their vBot while properly following all directions, prompts, or commands within the rules of the contest which may be available to them through a visible medium such as Screen/View. All competitors may see the same screen/view at the same time through the same or different mediums to provide fairness. Simultaneous game play may be presented using various methods familiar to one skilled in the art. Each contest may have a set number of place finishers to qualify for a prize(s) promoted through the marketing of the contest.

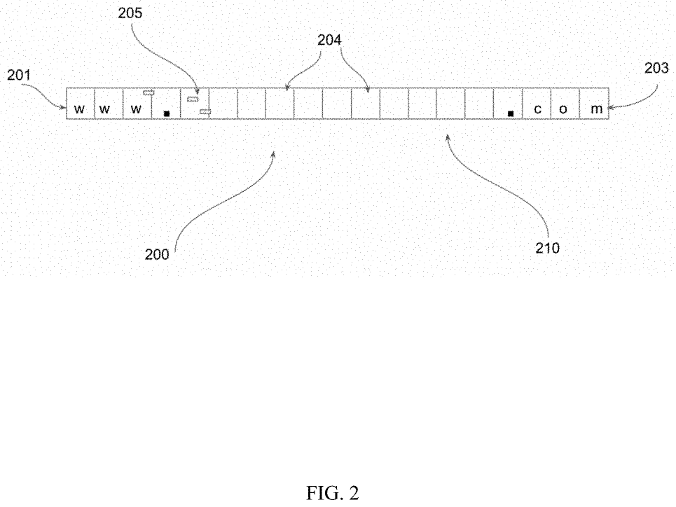

gamified ecosystem FIG. 2 illustrates a QTrack block 200 in accordance with embodiments described herein. The QTrack block 200 may include a URL 210 or other distance measurement. In FIG. 2, the URL 210 begins at point 201 with the letters “www” and ends at point 203 with the letters “.com.” There is no set length of a URL 210. A vBot 204 may represent any segment of the URL 210 that is assigned to a user to complete a race. Spanning a length of the URL 210 is a QTrack 205. The QTrack 205 represents a distance that competitors may traverse in a race competition. The QTrack 205 is not limited to a length of a URL and may take on various lengths and contest requirements as described herein.

Embodiments include multi-use capabilities, placement, and versatility of the QTrack 205. Within a digital environment the QTrack 205 (represented as a manually generated signal transmission between two or more points) may act or exist within the connective tissue of a digital transaction between two points such as 201 and 203. Those different points may take on a likeness of two servers, hardware or software, allowing a vBot competition to exist within or as a signaling mechanism or apparatus that occurs electronically online. The competition may be between forms, server pings, user interfaces, graphical user interfaces of a uniform resource locator(s) (URL), uniform resource identifier(s) (URI), web address(s), or series of two or more URL's, URI's, or web addresses.

Instead of a signal, transmission, or submission occurring as a single block of information, the signal or stream of data many also be broken into several pieces. Those pieces may be lined up in single file along a vertical or horizontal axis and assigned a vBot for which an individual or several individuals may act as a group to control a single vBot, and are given a query. When given the query a signal starts to manually generate a race to determine which aspect or piece(s) of the signal is able to accelerate across the predetermined QTrack distance of the signal transmission line (Vector A,B) 100 (illustrated in FIG. 1). Each competitor may power their vBot by manually inputting correct Assigned Values into the preset Assigned Value Spaces (Puzzle/Query) presented on the Screen/View in front of them. The first competitor(s) to cross the finish line wins the contest by being responsible for the fastest manual transmission of the signal. Similar to a new web domain in which no person has ever visited other than the host, with the Query (Assigned Values) made available on the screen to competitors for manual input, competitors will race across the QTrack 205 that sits on top of the URL 210. To sit on top of may have the meaning the QTrack spans a length of the URL 210, or other set distance measurement. The first vBots 204 to arrive at the destination would be responsible for a signal with their IP Address arriving at the destination web address in order.

In other words, a physical track or a virtual/digital track with interchangeable characters may represent a web URL. The URL itself represents the characters that someone can physically see on an illuminated strip of track or with the help of Augmented and Virtual Reality hardware. When typing “www.” one's vBot may move to the starting line. The QTrack is revealed but it also happens to be a hyperlink/URL/web address which every competitor is displayed at the same time. From the perspective of the individual looking at a physical track through AR glasses, for example, the QTrack (with the assigned values to be inputted) sits on top of that physical track. Embodiments include an ability to use a QTrack as a form of incentivized behavioral engagement and information literacy.

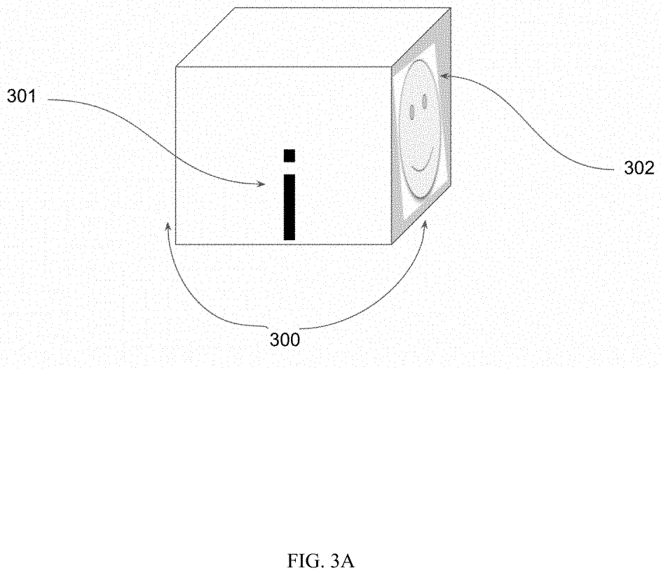

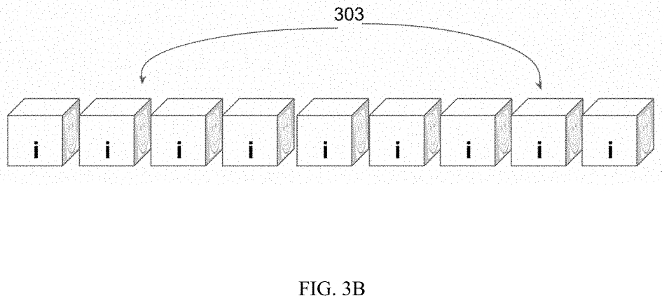

FIG. 3A illustrates a container 300 in accordance with embodiments described herein. FIG. 3B illustrates a number of blocks 303 in a QTrack in accordance with FIG. 3A. In FIG. 3A, the container 300 is demonstrated in which each assigned space or assigned value may be used more than once to create the container 300. The container 300 may hold mass within it, may hold value, which leads to an idea of domain estates. Domain estates allows a distance traveled and the value that comes along with it to be amassed in the container 300, which may be used to monetize data. The different images displayed on the container cube such as the smiley face, checkerboards 301a, column 302, and sphere represent different types of media or human performance that may be entered into a race such as a Text Race™.

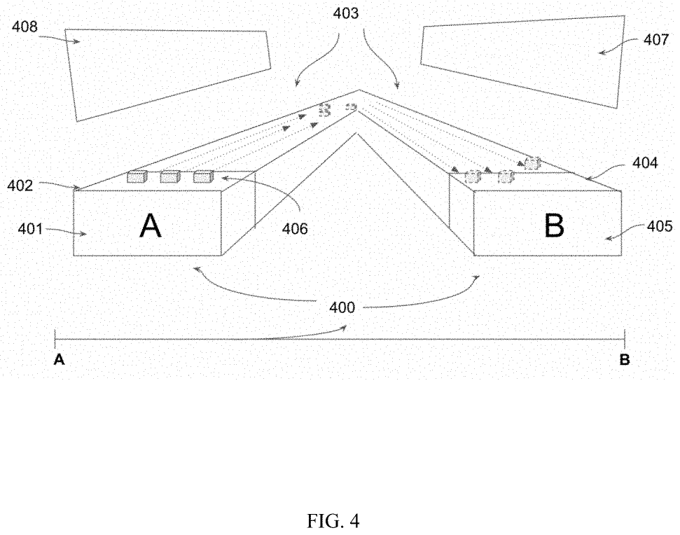

FIG. 4 illustrates one version of a QTrack atmosphere 400 in accordance with embodiments described herein. In the QTrack atmosphere 400, space between points A 401 and B 405 may be represented as a physical track 403. A metaphor of the racetrack 403 includes vBots 406 in a form of race cars. The space between A and B may be made any length and may constitute any number of algorithms and courses of action as described herein. When displayed virtually, QTrack atmosphere 400 may include advertising panels 407 and 408 to be made available to sponsors of a race. In a race, there may be hundreds or thousands of participants and advertising to racers could be lucrative for advertisers. The QTrack 403 may include a starting line 402 and a finish line 404. When a user enters a URL they may arrive at the starting line 402. Participation in the designated activities will result in the user achieving the finish line 404. The system may track with specificity the progress of a race to determine which vBot arrives at the correct answer first and in other places.

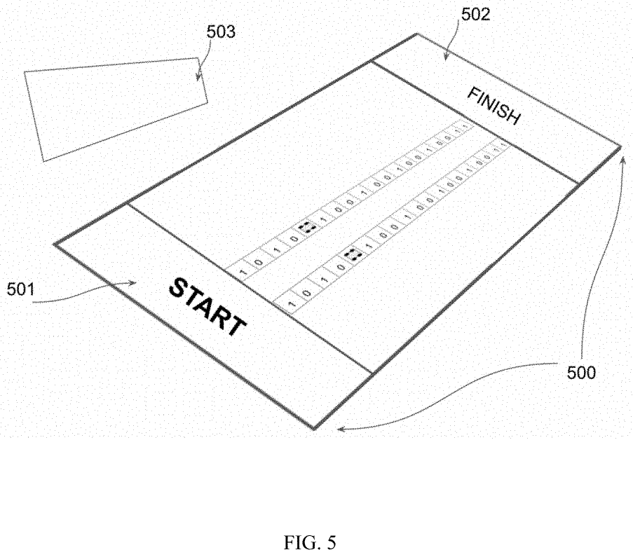

FIG. 5 illustrates a cube 500 version of a QTrack race in accordance with embodiments described herein. Similar to FIG. 3, a cube 500 may take on multiple races at a time. One race may be seen to take place at a top surface of the cube 500, while other races are taking place at different areas of the cube 500. Blocks can be broken into different segments. Because the environment is quantum, the environment can be made to expand or contract. The region 501 may be the starting point for one or many vBots. The region 502 designated as the finish line. Between the starting point 501 and finish line 502 may be any number of different races representing tasks to be performed by one or more users. The region 503 may represent advertising space.

Embodiments include an ability to use QTracks and related contests as a way for educating specific demographics on a subject matter. Embodiments include an ability to use the gamified engagement ecosystem as a way of teaching, tutoring, testing, scoring, educating, evaluating, training, accounting, influencing, incentivizing, gamifying, and/or visualizing the rate or level of understanding by an individual or group of individuals on a specific subject matter. Competitions between user classes include but are not limited to corporations, institutions, organizations, groups, individuals, and governments to participate in polls, votes, censuses, surveys, and applications to increase engagement that are able to accelerate or move a vBot using the input of Assigned Values found on a QTrack.

A QTrack contest or QTrack driven signal may be compared to a watch with a seconds hand that ticks from moment to moment with a noticeable start and stop of movement. Embodiments described herein allow for each Assigned Value Space in addition to a Properly Assigned Input Value to use the Input Value Mechanism or Apparatus along the QTrack to act in non uniform increments, but compartmentalized action that ticks forward asymmetrically. A length of each tick, unlike a clock, may not be an exact same length of time. This is reflected in that not all competitors will input values with the same consistency or accuracy.

Aspects of vBot movement include a vBot or vBot competition that is able to move through, along, or on top of the input of Assigned Values between two distinct points (QTrack) as the signal of a transmission between mobile devices, mobile device to computer, computer to mobile device, computer to computer, computer to server, mobile device to server, mobile device to machine learning system, software to software, software to hardware, hardware to software, and hardware to hardware.

Embodiments may operate like an online television show in which competitors will have live-streamed access at the time of the contest/race event. This function would be like the “Wheel of Fortune®” game show. In present embodiments, each space is recognized as an Assigned Value Space awaiting the Assigned Value to be Inputted allowing for the vBot that sits at the starting Point “A” of the Vector (A,B). The Assigned Value Space is accelerated forward as the negative space is inputted/keyed in by competitors.

Embodiments described herein include an ability to evaluate Input Values of one or more competitors within a QTrack-based contest using any of the following methods including but not limited to specialized software, rules engines, if-then based code, artificial intelligence, a URL-based QTrack venue that allows a QTrack to function as a hyperlink, signal recognition, frequency recognition, or transmission of inputted values through digital based filters or mediums. These may be used for the purpose of ensuring that the Assigned Value Inputs entered in proper sequence with receipt systems and enclosed to verify an exact time of an input value are entered by one or more competitors separately or within a group in relation to an internal clock. A time stamp is used to begin a contest including all functionality therein and through the completion of a contest.

Embodiments include a customization of Assigned Value Inputs. As described herein, Assigned Value Inputs may be inputted through a function of an Input mechanism/apparatus or customized button to allow competitors or end users to key in a sequence to solve a predetermined puzzle embedded within the QTrack.

vBots may function as a signaling or transmission of information moving at a manual speed determined by the end user's ability to manually input a series of values in the proper sequence or timing related to propelling the vBots of multiple competitors at varying speed from Point “A” Starting Line to Point “B” Finish-line.

Competitors are able to enter a series of inputs that represent the puzzle pieces ranging from characters of alphabetical, numerical, alphanumeric, symbols, images, file types including but not limited to, audio files, video files, GIFs, line of code, information, data, vote, energy, frequencies, air, water pressure, batter charge, and financial transactions.

The ability to convert the Assigned Value for each Assigned Value Space into any type of file, character, GIF, image, transaction, line of code, algorithm, information, algorithm, etc. allows for a Bit-Race™ to break into a number of sub-categories that interface with multiple markets and industries. Examples include a group of competitors that show up and vote and may maneuver an individual or group vBot across a QTrack designed in the political realm. Information literacy would allow for competitors to study for a subject in school and based on their ability to complete an assignment such as tests, homework, or attendance, be positioned to accelerate their vBot across a QTrack first. The ability to customize these values to colors, picture pieces, emojis, symbols, etc. allow a Text Race™ to be a unique way of entering correct answers for any manner of subject matter.

Embodiments include diverse and customized input mechanisms for Assigned Value Entry such as computer or digital keyboard character reassignment. Hardware and software mechanisms may allow for the engagement of competitors in the process of a competition to input values both assigned and unassigned into device(s) including but not limited to keypads, controllers, digital keypads and keyboards, physical keyboards and keypads, electronic devices, wearables, systems tracking units, mobile devices, computer systems, microphones, pressure switches, sports equipment, or musical instruments. As such, all or some inputs entered may correspond with or are reassigned to an Assigned Value Space within the QTrack displayed on the screen and seen by the end-user.

Behavior change may be tied to the Bit-Racing ecosystem by adjusting hardware devices that produce a character input to translate their measured engagement, movements, or inputs into character values that can become Assigned Values along a QTrack. This may be a deconstructed keyboard that use specific movements across a topographic digital, virtual, augmented reality landscape. Inputs may be sensor based, wearable technologies, equipment, and movements that prompt competitors to accelerate a vBot across a QTrack using more than just their fingers to maneuver through a digital environment that overlays their engagements to fuel the UMi™ Scoring System.

Embodiments include a speed measurement apparatus to measure an assigned value entry by manual input mechanisms. Embodiments include an ability to measure a speed in which values are inputted into a digital environment or QTrack to accelerate vBot(s) based on accuracy and input speeds.

An Input Value Per Second Engine allows inputs for each vBot or end-user to be tracked, recorded, and measured to improve engagement related auditing as system capabilities extend beyond the fingertips of an end-user.

The Input Value Per Second Engine may enable all movements to be considered and files like audio files and images sitting on top of digital buttons to be used to input values in ways that potentially go beyond the traditional term “character.”

Embodiments include an ability to compete at a designated physical location or remotely in a QTrack or vBot related contest using augmented reality (AR), virtual reality (VR), holographic projections, and topographic digital overlay.

Embodiments include an ability to compete in a QTrack related contest in which vBots may move based on the Assigned Value Inputs of competitors competing directly against one another or as teams against other teams in real-time using any number of Input Value Mechanisms at one time or at the same time.

Embodiments include an ability to convert Assigned Value Spaces into personalized programming tools as a research gathering tool by fragmenting the QTrack into the electronic, digital, or virtual environment of the end-user. This may allow for information literacy to be coupled with a physical actionable behavior to create a larger trans-contextualized competition. The trans-contextualized competition may function as a product of the accumulation of smaller and at times faster competitions from within as incentivized engagement in conjunction with human behavior.

Embodiments include an ability to position Assigned Value Spaces around a specific activity, action, or form of engagement of the end-user to use an Input Value in a similar manner as any vBot driven contest. The position, timing, and value of each Assigned Value Space may be based on specific or unspecified research data produced by or influenced by a structured or unstructured dataset related to the end-user(s). Each aspect of engagement by the end-user may be measured and cross referenced with a number of related and or possibly nuanced datasets that may or may not have value to the end-user.

For example, a competitor participating in a version of the contest may input an Assigned Input Value using a body part of a customized Input Value Mechanism such as a sensor or node to solve a puzzle related to the subject matter of the activity.

In another example, research for a specific demographic may show that the hand position (Fully Extended Above Head) while lying on ones back for a specific demographic class of end-user(s) is the proper distance to determine a complete range of motion. This may be important or vital for understanding of that particular end-user's mobility, health or perhaps literacy surrounding the end-user's understanding about their own mobility and health. Placement of the Assigned Value Space based on the predetermined data regarding the verified size, shape, mass, length, width, dimensions or other variables can be measured by both Input Value Mechanisms and Apparatuses used to determine range of motion, and or understanding. This may be done by placing the QTrack at appropriate distances to incentivize or gamify an end-user to reach an optimal position for observation through community based participatory research of a niche demographic or profile to take place. The end-user is able to visualize the QTrack through the use of augmented reality, virtual reality, holographic, projection-based, mobile device, computer system, or frequency-based technologies to select the appropriate values.

In another example, a competitor whose range of motion based on community-based participatory research (CBPR) may be restricted to compete in broader vBot contests, that for purposes including inputting the Assigned Values required of a QTrack to accelerate their vBot to victory, may find that competitor having to consume or participate in specific programming for assistance, or purchase certain products for support of a healthier range of motion.

As described herein, competitors may compete for value in the following forms including but not limited to monetary cash, digital assets, coupons, gifts, rebates, prizes, games, additional competitions, trophies, services, goods, products, experiences, information, data, or other forms of value that a competitor(s) may want to utilize.

As described herein, competitors may utilize this system to mine for value within the digital environment of a QTrack. Value which may include but not be limited to fungible and nonfungible digital assets, crypto currencies, coupons, giftcards, digital real estate, products, goods, and services that may be used to purchase or trade for personalized products goods and services of interest to the end-user.

Embodiments include an ability to provide an algorithm driven scoring system that is configured to combine a total distance traveled by a vBot with context in relation to a behavioral change in an end-user.

Embodiments include an ability to aggregate a plurality of contests engaged in by an end-user. The ability may be based on the end-user(s) desires while taking into account a distance of a vBot traveled through an accumulated number of textually interwoven QTracks or related digital environments via nuanced datasets to produce a living score. The living score may fluctuate based on real-time and legacy engagement patterns and frequency of competitor/end-user using algorithms, software, hardware, QSCORA, and other metrics used to measure movement within the digital fabric.

For example, when competitors select and input appropriate Assigned Values into the Assigned Value Spaces of their QTrack, they are presented with an opportunity to race their vBot past competitors that are unable to do the same or to keep pace with other competitors that are able to do the same.

Embodiments include affiliate marketing and promotional opportunities including an ability for a social or market influencer to promote a QTrack-based competition for a specific subject or demographic market. The promotion may be in exchange for an “X” percentage of the total monetary value of a contest including advertising, sponsorship, entry fee, accumulated value, as well as peripheral value that may occur as a result of new products.

As noted herein, revenue streams may include entry fees, subscriptions, advertising, sponsorships, contained value, memberships, vBot customization, e-commerce, exchanges, league membership fees, team membership fees, grant amplification, and more.

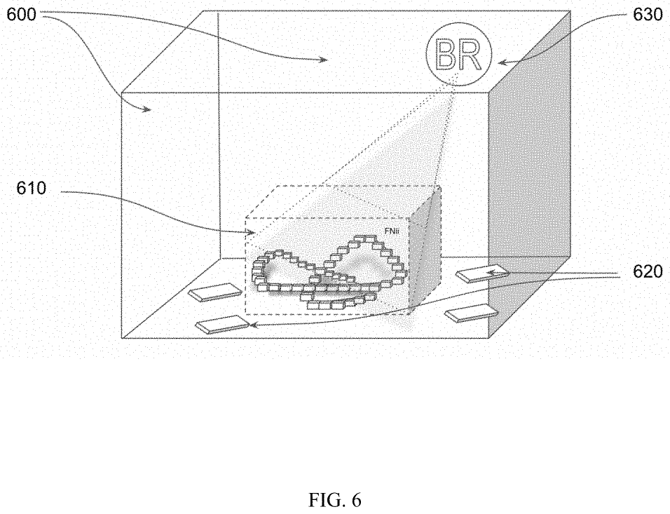

FIG. 6 illustrates a virtual reality representation 600 of a digital environment in accordance with embodiments described herein. Embodiments include an ability to broadcast a QTrack-based value assignment contest via live stream or non-live stream event over an electronic, digital, virtual, augmented reality medium. The QTrack value assignment contest may also be performed at a physical location, event, campaign, newspaper, magazine, fundraiser, via telephone, telegram, radio, satellite, Bluetooth®, and more.

As illustrated in FIG. 6, a virtual model 610 of financial insecurity (FNii) may be presented in a physical room of a user's establishment. A hologram or digital environment may be generated. Based on movements of a user through a QTrack 620 using an input scheme 630 such as Bit Racing™, users' maneuvers through the QTrack 620 could be displayed and tracked.

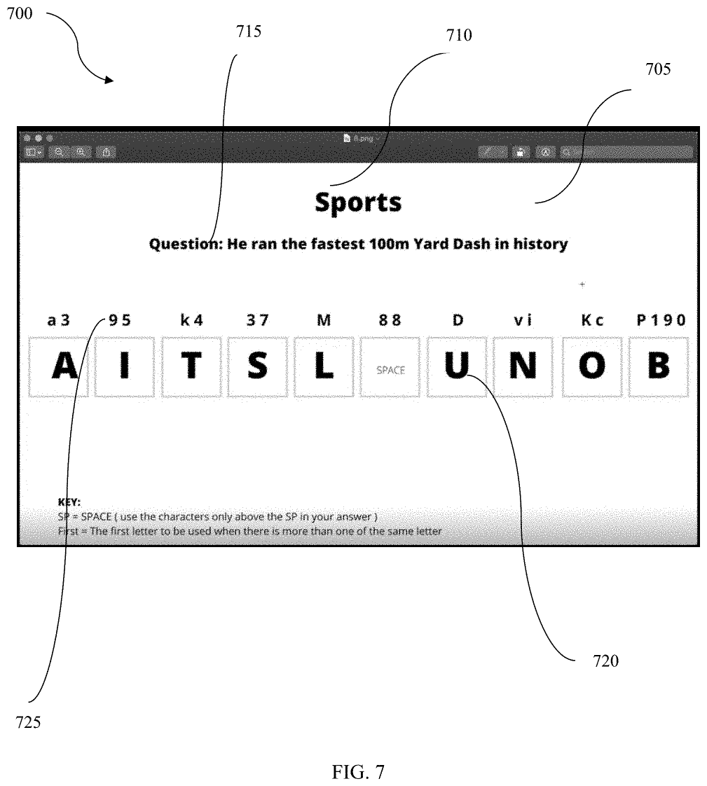

FIGS. 7-10 illustrate examples of value racing 700 in accordance with embodiments described herein. As illustrated, a screen 705 may be displayed to a user marked with one of many categories 710. In this case, “Sports” is listed as the category 710 on the screen 705. A query 715 is written under the category 710 to prompt a user to formulate an answer. Letters 720 are displayed on the screen 705 in a scrambled manner. Code letters 725 are displayed over each letter 720.

In operation, the screen 705 may be displayed on any number of user devices such as a laptop, smartphone, smartwatch, tablet, desktop, or the like. The value racing platform will provide prompts on the user devices to allow users to enter characters. Based on the category 710, query 715, and scrambled letters 720, users will be able to determine a correct answer. When a correct answer is determined, users will enter the code letters 725 representing each letter into an input field (not illustrated). Words with multiple letters may use characters such as dots or other mechanisms to signal which of the same letters should be typed first. The user to type the code letters 725 in the accurate order before the other users may be the winner of the character race.

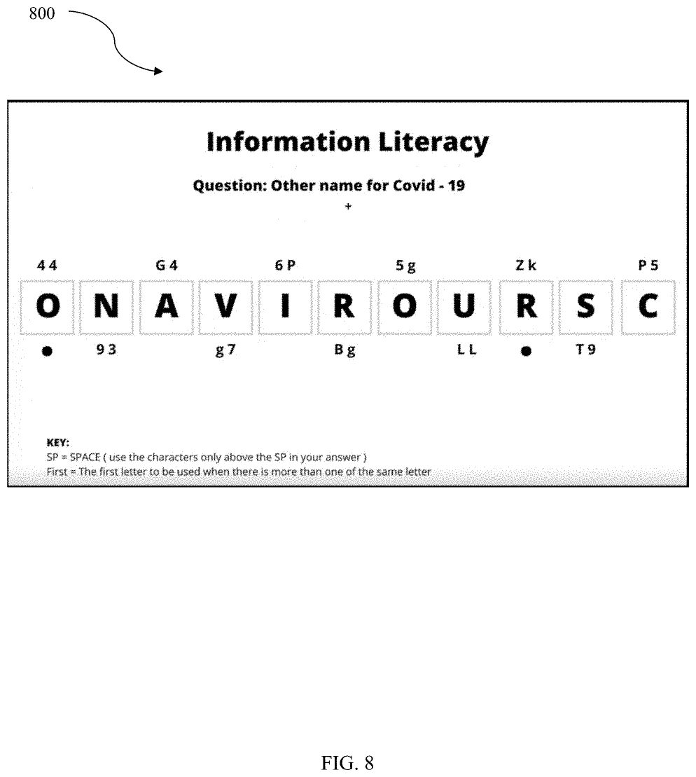

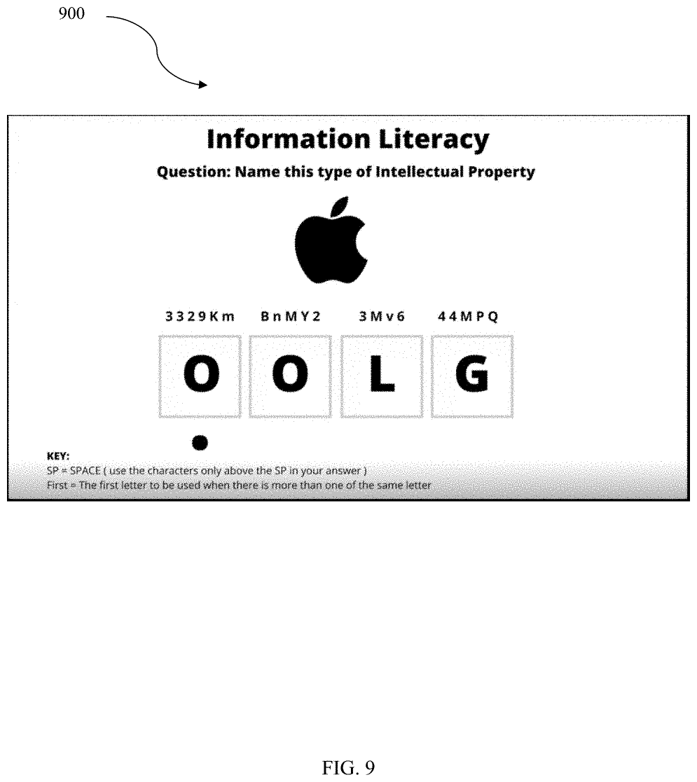

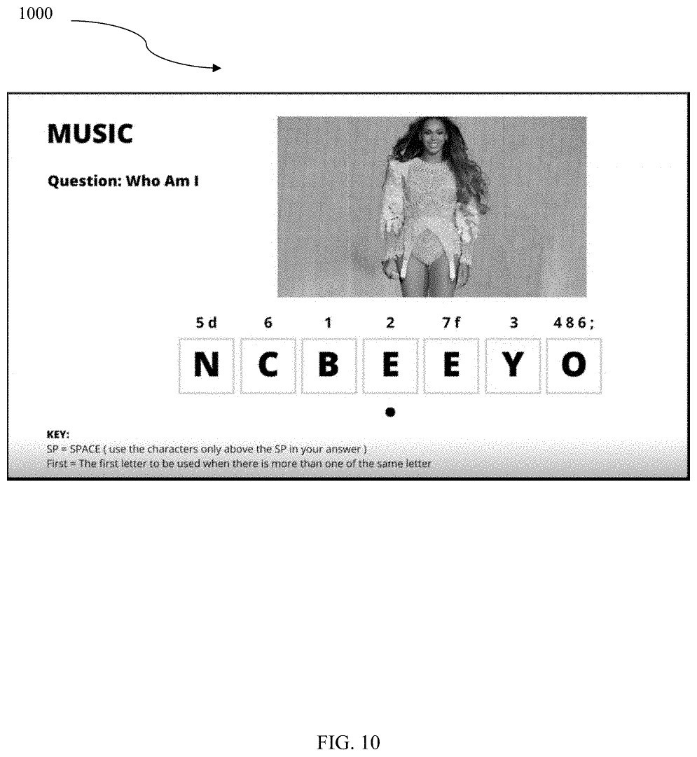

FIG. 8 illustrates an example character race 800 in a category of information literacy. FIG. 9 illustrates an example character race 900 in a category of intellectual property information. FIG. 10 illustrates an example character race 900 in a category of music.

FIG. 11 illustrates a method of determining a winner of value racing in accordance with FIGS. 7-10. The gamified ecosystem includes several modules that allows itself to determine a winner of a character race. A comparison screen 1100 includes different comparison fields in which data is entered and compared. In a scrambled field 1110 the scrambled word is displayed with code letters displayed atop the letters of the answer. An answer field 1120 includes a correct answer to the query. A drop zone 1130 includes a correct representation of the code letters 725 in response to a query. The correct code letters from the drop zone 1130 are displayed in a first portion 1142 of a comparison field 1140. Coded letters entered by a user are displayed in a second portion 1144 of the comparison field 1140. The gamified racing ecosystem compares correct code letters in the first portion 1142 with the user entered code letters in the second portion 1144 to determine if there is a match or an error. If there is an error, a user is prompted to try again. If there is a match, the first user to achieve a match is determined the winner.

Broadcasting the QTrack-Based Value Assignment contests also allow for real-time updates and engagement regarding any part or portion of a QTrack Contest or vBot related digital action. The real-time updates and engagement may include but are not limited to the starting time, start-line, live in-game or mid-contest progress, finish line, results reporting, participants entered, prizes awarded, store purchases, online purchase opportunities of related material including customization of QTrack and or contests, participant interviews, recordings, publications, cumulative reporting, database searching, related alternative market activities in relation to end-user(s) vs. end-user(s), channels or programming, and more.

Embodiments also include an ability to recycle or increase a value of any item that may be used as means of exchange. The ability to increase the value of donations, grants, financial currency, digital assets, alternative forms of currency, crypto, peer-to-peer financial assets and processes, real estate, online real estate, alternative coupons, rebates, discounts, and financial instruments.

Embodiments also include an ability to license technology and processes for marketing, promotional, and educational opportunities. The ability for business entities both for-profit, non-profit, public and private sector to purchase a hardware, software, lease, API, or other form of sector or cross-sectoral based form of monetization, promotion, marketing, value added, data gathering, data cultivation, artificial intelligence, data parsing, data visualization, fund raising, form submission, signaling between databases, servers, websites, incentivized teaching, tutoring, teaching, information literacy, or online and offline event planning promotion or campaigning, census data, engagement, or participation of individuals or groups within various communities.

Embodiments include an ability to pre-emptively impact or process point-of-sale transactions within or across a digital network or store. Abilities to use the technology platform described herein as a repository for value may allow competitors to hold onto their prize or participation value within an online or offline account, wallet, workplace, or profile. The value may be held for the purposes of, when ready, traversing proper channels of exchange within the guidelines, laws, rules, and statutes of governing bodies of the country or region for which a competitor or group of competitors resides or competes. Rules may be considered regarding assigned appropriate taxation to items produced by participating members of different user classifications. Items produced may include but are not limited to products, goods, services, programming, physical real estate, virtual real estate, digital assets, or web domains. Additional time within a certain or specified electronic, virtual, or augmented reality framework or environment accessible to specified end users may be included through technologies including hardware or software that have been accepted within the described framework or platform.

Embodiments also provide that a QTrack overlay may be used as a trans-contextual map for mental and physical engagement. Embodiments include an ability to move a competitor through a physical environment using the Assigned Values of a QTrack to become a real-time overlay merged with their physical reality. An individual may interact with their QTrack with suitable hardware or software technology to allow Assigned Values to be input based on a combination of multiple physical and mental actions in tandem or sequence to accelerate their vBot through a digital or humanistic environment.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware including several distinct elements. In the device claim enumerating several means, several of these means can be embodied by one and the same item of hardware. The mere fact that certain measures are recited in mutually different dependent claims does not indicate that a combination of these measures cannot be used to advantage

1. A method of playing a game, comprising:
registering a plurality of players to play the game, wherein the plurality of players are registered as digital vehicles;
creating user profiles based on registration information of the plurality of players;
presenting a race link to the plurality of players;
notifying the plurality of players of a beginning of the race;
unveiling a track to the plurality of players on which to receive the digital vehicles; and
accelerating the digital vehicles around the track based on player input of assigned values into assigned value spaces of the track.
